(19) United States
(12) Patent Application Publication
(10) Pub. No.: US 2007/0156513 A1
(43) Pub. Date: Jul. 5, 2007

(54) Coupon exchange network and service bureau

(76) Inventors: Steven J. Mastrianni, Unionville, CT (US); Clifford Pickover, Yorktown Heights, NY (US)

Correspondence Address: ANNE VACHON DOUGHERTY, 3173 CEDAR ROAD, YORKTOWN HTS., NY, 10598, US

(21) Appl. No.: 10/577,208

(22) PCT Filed: Nov. 26, 2003
(86) PCT No.: PCT/US03/37976

§ 371 Date: Jan. 26, 2007

(51) Int. Cl. G06Q 30/00

(52) U.S. Cl. 705/14

(57) ABSTRACT

The present invention provides methods, apparatus and systems for a coupon service facilitated by a coupon service bureau that manages the easy creation and exchange of targeted coupons created by users (150, 160) and other coupon associates. Moreover, immediate coupon information may be provided at the store using coupon devices that notify users (140, 170) about product information and the best discounts that are available at the current store or further advantages available at other stores (110).

### CROSS REFERENCE

This application is cross-referenced with Docket Number YOR920030471 PCT1, Serial number to be assigned, even dated herewith, entitled, “Dynamic Coupons,” and incorporated herein in entirety for all purposes.

### FIELD OF THE INVENTION

The present invention is directed to providing a coupon service facilitated by a coupon service bureau (CSB) that manages the easy creation and exchange of targeted coupons created by users and other coupon associates. Moreover, immediate coupon information maybe provided at the store using coupon devices that notify users about product information and the best discounts that are available at the current store or fer advantages available at other stores.

### BACKGROUND OF THE INVENTION

Various coupon distribution services exist on the World Wide Web. For example, at CouponSurfer.com, a service available in 2003, coupons are offered for reduced prices on such items as clothing, food, music, toys, and travel. Two types of coupons are typically offered. “Internet,” or on-line, coupons are provided for Internet on-line stores like Buy.com or Petsmart.com. On-line coupons can be redeemed by clicking on a link in a web browser. Once a user clicks on a link, the user is taken to a retailer's web site (e.g. Petsmart) where the user can use the coupon to make a purchase. In some cases, it may be necessary to enter a specific code or password on the retailer's web site to obtain a discount. If this is the case, specific instructions are included on the coupon. The second type of coupon offered at Internet coupon distribution services is a printable coupon. Users print such coupons using their computer's printer and physically take the coupons to a physical store, for example, a restaurant. These coupons may contain bar codes or other information so they can be scanned at the physical store's register.

One disadvantage of these coupon services is that they do not provide for a coupon service bureau (Coupon Service Bureau) that facilitates the easy creation and exchange of targeted coupons created by users and other coupon associates. Prior coupon services do not provides immediate coupon information at the store using coupon devices that notify users about product information and the best discounts that are available at the current store or further advantages available elsewhere. Current Coupon Service Bureaus also do not permit the convenient exchange of demographic information relating to the coupon user and store.

### SUMMARY OF THE INVENTION

In accordance with the aforementioned need, one aspect of the present invention provides a method for facilitating distribution of coupons for use at at least one store, where a first user makes a request to a coupon service bureau to obtain a targeted coupon for a targeted advantage, and then coupon service bureau forwards the targeted coupon to the first user. The targeted advantage includes such advantages as a product discount or a service contract feature. In some embodiments of the method, the user uses a portable coupon device for receiving the coupon and transmitting demographic information back to a third party like the store, coupon service bureau, or product manufacturer. Various characteristics of the coupon may be dynamic and change in real-time based on current weather, number of other users using targeted coupon, and other factors. The coupon service bureau may also allow coupon associates, such as other users, to exchange coupons.

### BRIEF DESCRIPTION OF THE DRAWINGS

These, and farther, aspects, advantages, and features of the invention will be more apparent from the following detailed description of a preferred embodiment and the appended drawings, wherein:

FIG. 1 shows an exemplary collection of several coupon associates who interact with the coupon service bureau;

FIG. 2 shows an exemplary procedure for coupon distributed to users; and

FIG. 3 shows an exemplary procedure for the Coupon Service Bureau facilitating the creation, bartering, auctioning, and exchanging coupons between one or more users.

### DETAILED DESCRIPTION OF THE INVENTION

The present invention provides methods, apparatus and systems for providing a coupon service facilitated by a coupon service bureau (CSB) that manages the easy creation and exchange of targeted coupons created by users and other coupon associates. Moreover, immediate coupon information may be provided at the store using coupon devices that notify users about product information and the best discounts that are available at the current store and/or flier advantages available at other stores.

To facilitate the use of coupons in the store, a first user may use an electronic portable coupon device (CD), which is more convenient to use than traditional paper coupons. Traditionally, the consumer brings a pile of coupons to the cash register of a physical store. The coupons are scanned, checked, and placed in a container for later pickup. At a later time, the coupons are again sorted and classified manually. No record is made of who used the coupon, what else they bought, and related buying information.

This invention may include a coupon device (CD) and a coupon service bureau (CSB) which may interact with the CD. The CD typically contains storage (for storing one or more coupons), a means for network communications, and an optional display. Coupons may be loaded to the CD via a computer network, paper scanner, or other electronic mechanism. For example, the first user may scan a magazine coupon to record the coupon, and the CD records pertinent information. Although this information may be stored for use on the CD, the Coupon Service Bureau may provide storage and management of numerous coupons, even those coupons that a user himself manually scans. The product name, price, and other coupon information may be recorded as part of the coupon information.

When the customer user visits the store to make a purchase, the clerk interacts with the CD, for example by swiping a coupon card, which validates the customer's coupon and records the coupon information, including such items as the current date, price paid, an enumeration of other items purchased. When coupons expire, they may be modified, for example, by automatic removal from the CD and/or by changing their appearance. The coupon may be graphically modified. For example, it may fade or have a red stripe through it. The coupon's targeted coupon value may change, for example, it may change to the usual product price once the coupon has expired. The coupon may be moved from one location to another. For example, once the coupon has expired it may be moved to an expired folder on the CD. Other folders may be used to indicate other aspects of the coupons as a way to organize the coupon on the CD. For example, folders may be used for different classes of product, different price ranges, and ranges for expiration dates. Some folders may be password protected so that the coupons within the folder cannot be reviewed without the user supplying a password. Certain folders may be accessible to others. For example, a user may wish to expose her coupons for products she is not likely to buy before the expiration date. Other users may inspect this folder and offer to exchange their coupons for hers.

At any time, the Coupon Service Bureau may upload coupons to the device, or they may be sent to users without CDs via e-mail or by other means. A user may use the CD to scan the newspaper coupons and record the relevant coupon information. The cashier simply interacts with the CD, coupons are checked against the register receipt and automatically applied and debited from the CD. In return, coupon suppliers may receive accurate, detailed demographics about customer purchases.

The coupon device (CD) may be any of: card, smart card, PDA, cell phone, handheld device, computer, and the downloading is done using any of: Internet, web, kiosk in store, kiosk in mall. The device may be provided by the store, product manufacturer, service provider, government, family member, and/or employer. Feedback to the Coupon Service Bureau may be done using a computer network and contains any of: demographic information, buyer information, product information, time of day, cost, and/or other products bought at the same time that the coupon was used. In turn, the Coupon Service Bureau bay send this information to stores, product manufactures, and other service providers. The Coupon Service Bureau may send to the user any of: product information, better offers at other stores, and/or duration that coupon is good for.

A coupon service bureau (Coupon Service Bureau) may be a third party that manually or automatically does any of: alerts user of other similar coupons, alerts users as to location of products (both in the same store or at other stores), or suggests alternatives based on: price, quality, features, safety, existence of rebates, etc.

The coupon device permits electronic trading and exchange of coupons over a coupon exchange network maintained by the coupon service bureau. The electronic exchange of coupons may be between users via: barter, sale, and/or auction. The electronic exchange may be restricted by: time, location of store, location of exchangers of electronic coupons, product, and/or price.

The portable coupon device may present auxiliary information such as: advertisements, product information, product manuals, consumer reports, and/or safety information.

The coupons may actually be created by the users of the coupon device and network or other agencies. For example, a user can create a coupon for a product, send it over the network via the coupon exchange network to a friend, who can use the coupon to get a discount on a product. This “virtual coupon” will deduct money from the sender's account and function as a gift.

The coupons may expire. The users maybe groups of individuals, companies, corporations, community groups, and/or governmental groups. The coupons may be used to obtain other coupons for “discounts.” For example, a user may trade his $10 coupon for coffee for two $5 coupons for tea.

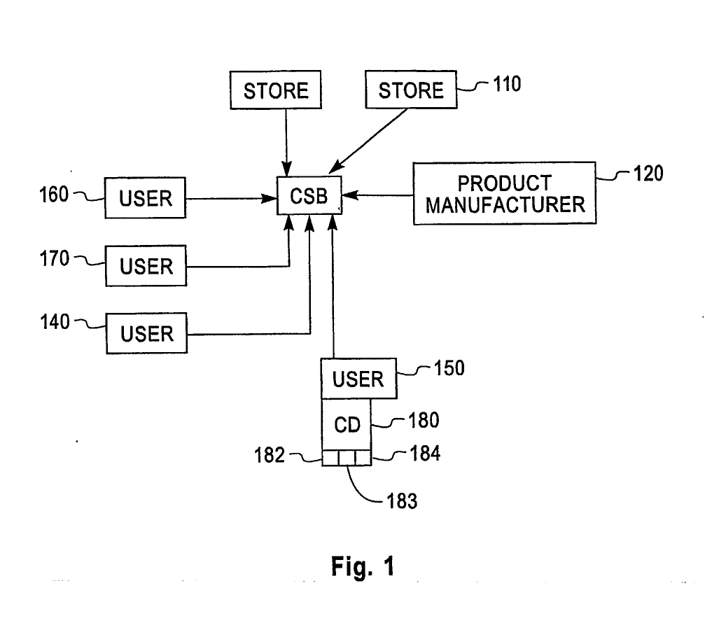

FIG. 1 shows several coupon associates such as stores 110 and product or service creators 120 who provide coupon information to the coupon service bureau (Coupon Service Bureau) 130. Such information may include product or service information and various targeted advantages such as the amount of discount for product or service and duration of discount. Other targeted advantages include rebates, product features (e.g. a product of a certain preferred color), service features (e.g. a service with preferred terms and conditions)j service contract feature (e.g. the product comes with a 3-year warranty and free inspections), ecological friendliness (e.g. a product that does not pollute the environment), safety features, and preferred instructions (e.g. an easy-to-read and in-depth manual).

The information may also include an identification of the specific recipient for the advantage. Also depicted are users 140 and 150, to whom the Coupon Service Bureau sends coupon information. User 150 has an electronic coupon device 180 (CD) which contains the coupon information supplied by the Coupon Service Bureau 130. Other users 160 and 170 need not be recipients of the coupon information but can be potential creators of a virtual coupon to be sent to users 140, 150. In this case, these other users are coupon associates just like a store of product manufacturer.

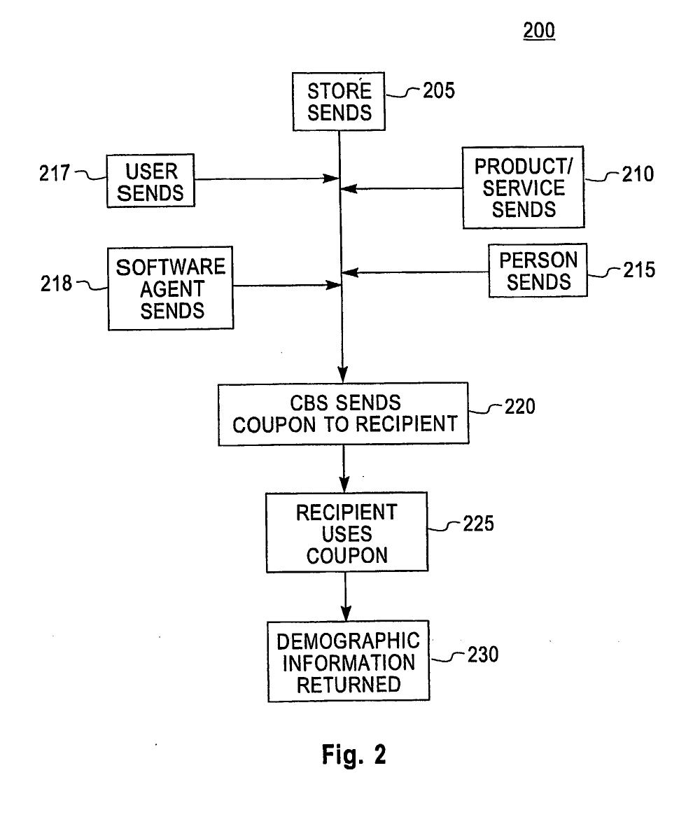

FIG. 2 shows how coupon information is distributed to users 140, 150. In step 205, an associate, such as a store, sends coupon information to the Coupon Service Bureau 130. In step 210, an associate, such as a product or service creator, sends information to the Coupon Service Bureau. In step 215, an associate, such as another user 160, sends information to the Coupon Service Bureau. For example, another user 160 may wish his friend to receive a targeted advantage, such as a $10 discount on eyeglasses. Thus, the information in this case may contain a product identifier, discount, and recipient identifier such as a string of alphanumeric characters. This user-made coupon is a virtual coupon, because no manufacturer or store initiated it In step 217, the user of the Coupon Service Bureau may himself send targeted coupons to the Coupon Service Bureau for his subsequent use. For example, a user may see a coupon in a magazine or at a web page and want the Coupon Service Bureau to store and organize such coupons for later use by the user. In some cases, associates, such as stores, manufactures, and service providers, will provide a recipient (i.e. user) identifier so that a coupon may be used only be a particular recipient. In other words, at least one coupon associate may provide an identifier enabling use of said targeted coupon by a limited user population such as a single user, family, employees in a company, workers in an office, a group of people in a particular age group.

In step 218, a third party agent, such as a software agent not associated with potential coupon associates 205, 210, 215, and 217, may create a coupon for a general population or a specific recipient designated by a recipient identifier. For example, to create a fluid economy or for other purposes, the agent may send discounts for home purchases to be made in a particular neighborhood. The software agent may be run by a government or other third party and/or be a self-functioning, independent agent.

In step 220, the Coupon Service Bureau sends the coupon information to a recipient 140, 150. In some cases, this information is sent because a recipient requested the coupon information, and it may reside on coupon device 180. In other cases, the recipient is sent this information even if the recipient did not request the coupon information, such as may be the case when a virtual coupon is sent by another user such as user 160. If the user has a CD 180, the information may be sent to the CD. If the user does not have a CD, coupons may be delivered by other means, for example by sending them to the user's computer, at which point he can print the coupon. A recipient (i.e. user) identifier code may control which person or CD can receive a coupon or can use the coupon.

In step 220, the Coupon Service Bureau may also modify said targeted coupon based on a coupon-modifying criteria such as: current weather (e.g. give discount if raining, or give snowshoe discount depending on weather), predicted weather, news reports, movies, movie show times, user's buying history, stores record of sales, time of day, number of sales for that day, speed at which product is selling prevailing market conditions, geopolitical events, fuel prices, demographic information (e.g. if the current buying rate for a product is low for 30-year-old women living in urban centers, the discount may change to incent new demographic buying patterns), traffic patterns, gas prices, prevailing economic conditions (stock markets, taxes, tax deductibles etc.), number of people in store at the moment or predicted to be in the store, time of day (e.g. to avoid rush hour traffic), terrorist alert level, nature of stores along the way to destination store, historical record of traffic problems (e.g. congestion), historical record of accidents, and crime statistics.

In step 225, a user uses the coupon information. For example, the information may reside on the user's coupon device 180 which the user brings to or uses in the store. The cashier may scan a barcode displayed on the CD or use some other common electrical interface to the coupon device in order to register the discount. In the cases for which coupon use is restricted to aparticular recipient, a password may be required to validate the user. In the cases of virtual coupons, the sender 160 who sent 215 the virtual coupon may have his account debited by the Coupon Service Bureau to pay for the discount. In step 225, the user may also receive product information, manuals, ads, rebates, comments, and other material related to the product and provided to the Coupon Service Bureau 130 by the stores, manufactures, associates, and/or third parties such as consumer reporting agencies. The Coupon Service Bureau may also notify the user of further advantages, such as discounts, available elsewhere and of safety concerns.

In step 230, user-specific information about the purchase may be sent back to the Coupon Service Bureau, with the user's consent. For example, this information may include demographic information about the buyer, which the Coupon Service Bureau may send to the associates, such as store 10 or product manufacturer 120 or agent 218. Demographic information may include user buying history or other characteristics of the user. The information sent back can include non-demographic information, such as the time of day, rate of purchases in the store for a given time, and weather patterns so that stores and product/service creators will better understand buying scenarios and situations. User-specific information may also include: time of day of the step of accessing, time of day of the step of employing, product information, rate of purchases in a given time for a given product or products, and user's age, gender, income, place of residence, marital status, number of family members, past buying habits, level of education, hobbies, race, religion. The Coupon Service Bureau may charge the user and the associates, such as the store, agent 218, person 215, or product/service creator a fee for this service represented in steps 200, for example, by taking a percentage of each transaction. To accomplish this, the coupon service bureau meters the number and nature of: user requests, coupon service bureau forwardings, user redemptions—and then bills the first user according to the number and nature of requests, forwardings, and redemptions (step 225). The bureau may charge a set amount for each request, forwarding, or redemption, or the bureau may charge a percentage of the purchase price and/or discount value. The fee may also depend on the nature of the advantage given. For example, a discount may incur a greater fee charge than a rebate offer.

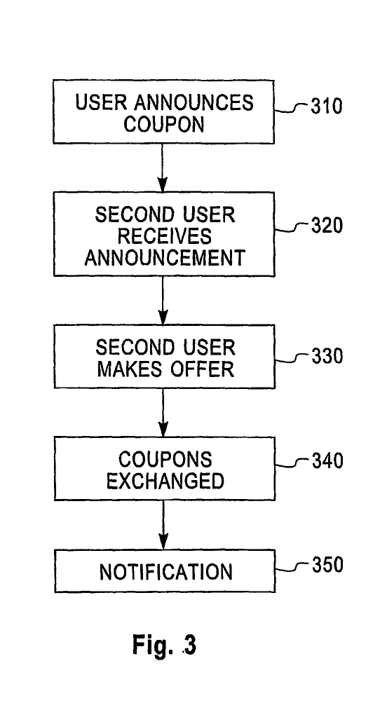

In FIG. 3, the Coupon Service Bureau 130 allows a first to create, barter, auction, and exchange coupons with another user—with or without involvement of the product manufacture or store. For example, in step 310 a user 140 may indicate to the Coupon Service Bureau 130 that he has a coupon for a particular product that he is willing to return and trade for another coupon. In step 320, another user receives the announcement of this first coupon via the Coupon Service Bureau 130 and can make an offer to the first user, For example, an offer might be made to exchange the coupon offered by the first user in step 310 for a different coupon offered by the second user in step 330. If the offers are agreed upon, the Coupon Service Bureau exchanges 340 one coupon for the other. Both users are happy. Optionally, coupon associates, such as the sellers or product/service creators, maybe notified 350 of this exchange, along with the demographics of the users, to best understand buyer needs and demographics.

Note that the “users” in FIG. 3 need not be limited to potential customers but may be other entities like sellers 205, 210 or software agents 218. In other words, these other entities may wish to exchange coupons.

Thus, the present invention provides a coupon service facilitated by a coupon service bureau (CSB) that manages the easy creation and exchange of targeted coupons created by users and other coupon associates. In particular, the present invention provides a method for facilitating distribution of coupons for use at at least one store, comprising: a first user making a request to a coupon service bureau to obtain a targeted coupon for a targeted advantage; and the coupon service bureau forwarding the targeted coupon to the first user.

In some embodiments of the method, the targeted advantage is an advantage taken from a group of advantages consisting of: a product discount; a service discount; a duration of discount; a rebate; a service feature a service contract feature; a product feature an ecological feature; a safety feature; a preferred instruction, and any combination of these advantages. As an example, a prospective buyer of a lawnmower may use the CSB to obtain a targeted discount on a lawnrower. To obtain this discount, the user may use his coupon device to enter the word “lawnmower” and a maximum spending price and a special safety feature. Entry may be by keyboard, speech, or other computer input means. The CSB may then send coupons to the user's coupon device such that the lawnmower will be below this price. These coupons are generally created by coupon associates, such as the product manufacturer, store, or even a friend who has created such a coupon. In fact, the targeted coupon may be created by a coupon associate such as a particular store, a chain store, a customer environment sensor, a weather sensor, a product manufacturer, at least one other user, a product manufacturer, a service provider; a goverrnent agency, a family member, an employer of the first user, the first user, a third party agent, and any combination of these associates. The word sensor refers to any detecting entity. For example, a weather sensor may determine that temperature is below 32 F and snow is likely, and thus alter the coupon discount for boots.

The coupon device can be a handheld device, a computing device, a smart card, a PDA, and/or a cell phone. The coupon device may be provided to the first user by a coupon provider such as the Coupon Service Bureau, the at least one store, product manufacturer, a service provider, a government agency, a family member, an employer of the first user, and any combination of these. While a user is using the coupon device in one store, the coupon device may notify the user of another store in which the user can obtain can obtain a furher advantage, such a a better discount and/or a better product feature.

Users may receive many different kinds of targeted advantages, such as product discounts, service discounts, duration of discounts, rebates, service features, service contract features, product feature, ecological feature, safety feature, preferred instructions, an independent software agent and any combination of these advantages. The software agent need not be associated with stores, product providers, service providers, and/or the user.

The Coupon Service Bureau may obtain the targeted coupon from the first user as well as user-specific information from the first user. The user-specific information includes first user demographic information (such as home address), time of day when coupon was made, time of day when coupon was employed (e.g. redeemed at a store), product information, rate of purchases in a given time for a given product or products, and a user's age, gender, income, place of residence, marital status, number of family members, past buying habits, level of education, hobbies, race, and religion. Demographic information may reside in a user profile on the consumer device, coupon service bureau, and/or at another location. Coupon associates may find such information useful in order to understand and plan product marketing. At least one coupon associate may monitor and store usage data for the targeted coupon.

Targeted coupons may be modified in various ways based on different criteria. For example, an advantage like a discount price, and reflected by numbers on the coupon and color of the coupon, may depend on expiration date, number of other users using targeted coupon, current weather predicted weather, news reports, movies, movie show times, user's buying history, stores record of sales, time of day, number of sales for that day, speed at which product is selling, prevailing market conditions, geopolitical events, fuel prices, demographic information, traffic patterns gas prices, prevailing economic conditions, number of people in store at the moment or predicted to be in the store, time of day, terrorist alert level, nature of stores along the way to destination store, historical record of traffic problems, historical record of accidents, crime statistics, and any combination of these criteria.

The coupon may be modified in many ways. For example, the coupon displayed on the coupon device may be deleted, have its discount value or other advantage changed, and/or can be moved from one location to another. For example, coupons may be stored in different folders or otherwise categorized on the graphical user interface. Graphical modifications include coupon color, size, font, texture, intensity, blink rate, texture, and background pattern.

A vast arena of peer-to-peer and related commerce is facilitated by the coupon service bureau. For example, at least one coupon associate can receive a targeted coupon or coupon use data from at least one other coupon associate from the group of targeted coupon associates. At least one coupon associate can redeem the targeted coupon after use of the targeted coupon by the first user. For example, a user could receive a coupon for a computer that is available in a town that is close to her friend. The user may then forward this coupon to her friend for his potential use.

This step of forwarding includes requiring a return of a previous coupon from the first user to the Coupon Service Bureau. The step of forwarding may include another user providing the targeted coupon to the Coupon Service Bureau in exchange for a previous coupon held by the first user.

A coupon associate may provide an identifier enabling use of the targeted coupon by a limited user population. For example, a manufacturer of certain medications may make a coupon advantage available to certain people who may benefit from the medication. One method for employing the coupon service bureau involves a coupon user 150 employing a portable coupon device 180 to provide user information in the form of a coupon, an information processor 182 for using the user information in providing a coupon advantage to the coupon user, and a coupon downloader 183 for downloading a coupon to the device, and an information transmitter 184 to provide feedback to at least one coupon associate. The processor, downloader, and transmitter can be located in one or more places, such as on the coupon device or on a computer located at the service bureau. The downloading is done from a provider such as an Internet provider, a web site, a kiosk in a store, and/or a kiosk in a mall.

The feedback includes data taken from groups of data including demographic information, buyer information, product information, time of day, service cost, product cost, and any combination of these data Feedback to device users may include special information taken from a group of special information including product information, better offers at other stores, duration that coupon is good for and any combination of these special information. The coupon service bureau maybe a third party that performs a task taken from a group of tasks including: altering user of other similar coupons, alerting users as to location of products, and suggesting other coupon advantages.

The coupon device permits the user to electronically trade and exchange coupons over a coupon exchange network maintained by the coupon service bureau. The coupon exchange employs an exchange technique taken from a group of techniques including: barter, sale, auction; and any combination of these techniques. The electronic exchange is restricted by a restriction taken from a group of restrictions including: time limitations, location of a store limitations, location of exchangers of electronic coupons limitations, product limitations, and price limitations.

The portable coupon device may present auxiliary information such as advertisements, product information, product manuals, consumer reports, and safety information. The coupon information is created by a user or other agency. For example, a user can create a coupon for a computer, send it over the network via the coupon exchange network to her friend, who can use the coupon to get a discount on the computer. This virtual coupon will deduct money from the user's own account and function as a gift. The user maybe individuals, companies, corporations, community groups, and governmental groups. The information may be used to provide a set of coupons to the user. The user sends particular coupon information to the Coupon Service Bureau. For example, he scans a magazine coupon and has the Coupon Service Bureau hold it for him for convenience and later use. If desired, the coupon may only be used by a particular recipient. The provider of the coupon information may be a software agent.

Thus, the invention includes a method for facilitating distribution of coupons for use at one or more store. In an example embodiment the method includes the steps of: a first user making a request to a coupon service bureau to obtain a targeted coupon for a targeted advantage, and the coupon service bureau forwarding the targeted coupon to the first user; and/or the coupon service bureau meters the number and nature of user requests and the number and nature of coupon service bureau forwardings, and bills the first user according to the number and nature of requests or forwardings; and/or the step of making includes employing a coupon device; and/or the coupon device is a device taken from a group of devices including: a handheld device, a computing device, a smart card, a PDA, a cell phone; and/or the coupon device is provided to the first user by a coupon provider from a group of coupon providers including: the Coupon Service Bureau, the one or more store, product manufacturer, a service provider, a government agency, a family member, an employer of the first user, and any combination of these; and/or the targeted advantage is taken from a group of targeted advantages including: product discount, service discount, duration of discount, rebate, service feature, service contract feature, product feature, ecological feature, safety feature, preferred instructions, an independent software agent and any combination of these advantages; and/or the Coupon Service Bureau obtains the targeted coupon from the first user; and/or the user-specific information includes one or more piece of information taken from a group of information including: first user demographic information, time of day of the step of making, time of day of the step of employing, product information, rate of purchases in a given time for a given product or products, and user's age, gender, income, place of residence, marital status, number of family members, past buying habits, level of education, hobbies, race, religion; and/or the coupon information includes information taken from a list of information including: product information, service information, an amount of a discount, a duration of the discount, a specific set of recipients of the discount, and any combination of these; and/or the provider of the coupon information is a software agent.

In some embodiments the method further comprises the targeted coupon being created by one or more coupon associate taken from a group of coupon associates including: a particular store, a chain store, a customer environment sensor, a weather sensor, a product manufacturer, one or more other user, a product manufacturer, a service provider, a government agency, a family member, an employer of the first user, the first user, a third party agent, and any combination of these associates; and/or the one or more store referring the first user to one or more other store from which the first user can obtain a further advantage; and/or obtaining user-specific information from the first user; and/or modifying the targeted coupon based on a coupon-modifying criteria including a criterion taken from a group of criteria including: expiration date number of other users using targeted coupon current weather predicted weather news reports movies, movie show times user's buying history stores record of sales time of day number of sales for that day speed at which product is selling prevailing market conditions geopolitical events fuel prices demographic information traffic patterns gas prices prevailing economic conditions number of people in store at the moment or predicted to be in the store, time of day terrorist alert level nature of stores along the way to destination store historical record of traffic problems historical record of accidents crime statistics, and any combination of these and such criteria; and/or the step of modifying the targeted coupon includes modifications taken from a group of modifications including: deleting the targeted coupon, graphically modifying the targeted coupon, changing the targeted coupon value, and moving the targeted coupon from one location to another; and/or one or more associate from the group of coupon associates monitoring and storing usage of the targeted coupon; and/or one or more coupon associate receiving targeted coupon use data from one or more other coupon associate from the group of targeted coupon associates; and/or the one or more coupon associate redeeming the targeted coupon after use of the targeted coupon by the first user, and/or one of the one or more coupon associate providing an identifier enabling use of the targeted coupon by a limited user population; and/or the step of forwarding includes requiring a return of a previous coupon from the first user to the Coupon Service Bureau; and/or the step of forwarding includes another user providing the targeted coupon to the Coupon Service Bureau in exchange for a previous coupon held by the first user; and/or the first user employing the coupon to obtain the targeted advantage at the one or more store; and/or the coupon service bureau meters the number and nature of user employing and bills the user according to the number and nature of employing.

In some embodiments, of the method, the targeted advantage is an advantage taken from a group of advantages comprising: a product discount, a service discount, a duration of discount, a rebate, a service feature, a service contract feature, a product feature, an ecological feature, a safety feature, a preferred instruction, any combination of these advantages and such.

The invention may be implemented as a system to provide coupon business to one or more stores. The system comprising: a coupon service bureau to-provide-coupon services to a group of users, one or more coupon creator to provide coupon information to the coupon service bureau, the coupon information being routed to a particular set of users from the group of users in satisfying a business criteria of one or more store from the one or more store.

In some embodiments of the system: the coupon information is related to an object taken from a group of objects including: one or more product, one or more service, a combination of one or more product and one or more service, a reward, and any combination of these; and/or one or more of the users has an electronic coupon device; and/or the electronic coupon device includes the coupon information; and/or the users are recipients of at least a portion of the coupon information.

The invention may be also implemented as an apparatus to facilitate distribution of coupons for use at one or more store. In an example embodiment, the apparatus includes: a coupon service bureau receiver to receive a request from a first user to obtain a targeted coupon for a targeted advantage, and a coupon service bureau transmitter to forward the targeted coupon to the first user.

The invention may be also implemented as an apparatus including: a portable coupon device used by a coupon user to provide user information, an information processor for using the user information in providing a coupon advantage to the coupon user, and a coupon downloader for downloading a coupon to the device.

In some embodiments, the apparatus further includes an information transmitter to provide feedback to one or more coupon associate; and/or the downloading is done from a provider taken from a group of providers including: an Internet provider, a web site, a kiosk in a store, and a kiosk in a mall; and/or the feedback includes data taken from groups of data including: demographic information, buyer information, product information, time of day, service cost, product cost, and any combination of these data; and/or the feedback to device users includes special information taken from a group of special information including: product information, better offers at other stores, duration that coupon is good for, and any combination of these special information; and/or the coupon service bureau is a third party that performs a task taken from a group of tasks including: altering user of other similar coupons, alerting users as to location of products, and suggesting other coupon advantages; and/or the coupon device permits the user to electronically trade and exchange coupons over a coupon exchange network maintained by the coupon service bureau; and/or coupon exchange employs an exchange technique taken from a group of techniques including: barter, sale, auction, and any combination of these techniques; and/or the electronic exchange is restricted by a restriction taken from a group of restrictions including: time limitations, location of a store limitations, location of exchangers of electronic coupons limitations, product limitations, and price limitations; and/or the portable coupon device presents auxiliary information: taken from a group of auxiliary information including: advertisements, product information, product manuals, consumer reports, and safety information; and/or further comprising the coupon information being created by a user or other agencies; and/or the user is a user taken from groups of users including: individuals, companies, corporations, community groups, governmental groups and such; and/or the user information is used to provide a set of coupons to said user; and/or the user sends particular coupon information to the Coupon Service Bureau; and/or the coupon may only be used by a particular recipient.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. A method for facilitating distribution of coupons for use at at least one store, comprising:
a first user making a request to a coupon service bureau to obtain a targeted coupon for a targeted advantage; and
said coupon service bureau forwarding said targeted coupon to said first user.

2. A method as recited in claim 1, further comprising:
the coupon service bureau metering at least one of: quantity of user requests, nature of user requests, quantity of coupon service bureau forwardings, and nature of coupon service bureau forwardings; and
billing the first user according to the number and nature of requests or forwardings.

3. A method as recited in claim 1, wherein the step of making includes employing a coupon device.

4. A method as recited in claim 3, wherein the coupon device is a device taken from a group of devices consisting of: a handheld device; a computing device; a smart card; a PDA; and a cell phone; and any combination of these devices.

5. A method as recited in claim 3, wherein the coupon device is provided to said first user by a coupon provider from a group of coupon providers consisting of: the Coupon Service Bureau; said at least one store; a product manufacturer; a service provider; a government agency; a family member; an employer of said first user; and any combination of these providers.

6. A method as recited in claim 1, wherein said targeted coupon is created by at least one coupon associate taken from a group of coupon associates consisting of: a particular store; a chain store; a customer environment sensor; a weather sensor; a product manufacturer, at least one other user; a product manufacturer; a service provider; a government agency, a family member; an employer of said first user; said first user; a third party agent; a software agent; and any combination of these associates.

7. A method as recited in claim 1, wherein the targeted advantage is taken from a group of targeted advantages consisting of: product discount; service discount; duration of discount; rebate; service feature; service contract feature; product feature; ecological feature; safety feature; preferred instructions; an independent software agent; and any combination of these advantages.

8. A method as recited in claim 1, further comprising a further step taken from a group of further steps consisting of: at least one store referring said first user to at least one other store from which said first user can obtain a further advantage; said coupon information being created by a user; said coupon information being created by another agency; and any combination of these further steps.

9. A method as recited in claim 1, wherein the Coupon Service Bureau obtains the targeted coupon from said first user.

10. A method as recited in claim 1, further comprising obtaining user-specific information from said first user.

11. A method as recited in claim 10, wherein the user-specific information includes at least one piece of information taken from a group of information comprising: first user demographic information; time of day of the step of making; time of day of the step of employing; product information; rate of purchases in a given time for a given product or products; and user's age; gender; income; place of residence; marital status; number of family members; past buying habits; level of education; hobbies; race; religion; and any combination of these pieces of information.

12. A method as recited in claim 3, further comprising modifying said targeted coupon based on a coupon-modifying criterion taken from a group of criteria consisting of: expiration date; number of other users using targeted coupons; current weather, predicted weather; news reports; movies; movie show times; user's buying history, stores record of sales; time of day, number of sales for that day; speed at which product is selling; prevailing market conditions; geopolitical events; fuel prices; demographic information; traffic patterns; gas prices; prevailing economic conditions; number of people in store at the moment or predicted to be in the store; time of day; terrorist alert level; nature of stores along the way to destination store; historical record of traffic problems; historical record of accidents; crime statistics; and any combination of these criteria.

13. A method as recited in claim 12, wherein said step of modifying said targeted coupon includes modifications taken from a group of modifications consisting of: deleting the targeted coupon; graphically modifying the targeted coupon; changing the targeted coupon value; and moving the targeted coupon from one location to another.

14. A method as recited in claim 6, further comprising a further step taken from a group of further steps consisting of:
at least one associate from said group of coupon associates monitoring and storing usage of said targeted coupon;
at least one coupon associate receiving targeted coupon use data from at least one other coupon associate from said group of targeted coupon associates;
said at least one coupon associate redeeming said targeted coupon after use of said targeted coupon by said first user;
one of said at least one coupon associate providing an identifier enabling use of said targeted coupon by a limited user population;
said first user employing said coupon to obtain said targeted advantage at said at least one store;
the coupon service bureau metering the number and nature of users employing coupons;
the coupon service bureau billing each of the users according to the number and nature of users employing coupons;
and any combination of these further steps.

15. A method as recited in claim 1, wherein the step of forwarding includes at least one of: requiring a return of a previous coupon from said first user to the Coupon Service Bureau, and another user providing said targeted coupon to said Coupon Service Bureau in exchange for a previous coupon held by said first user.

16. A system to provide coupon business to at least one store, said system comprising:
a coupon service bureau to provide coupon services to a group of users;
at least one coupon creator to provide coupon information to the coupon service bureau, said coupon information being routed to a particular set of users from said group of users in satisfying a business criteria of at least one store from said at least one store.

17. A system as recited in claim 16, wherein said coupon information is related to an object taken from a group of objects consisting of: at least one product; at least one service; a combination of at least one product and at least one service; a reward; and any combination of these objects.

18. A system as recited in claim 16, having a limitation taken from a group of limitations consisting of: wherein at least one of said users has an electronic coupon device;
wherein said electronic coupon device includes the coupon information;
wherein said users are recipients of at least a portion of the coupon information;
wherein said coupon information includes information taken from a list of information consisting of: product information, service information, an amount of a discount, a duration of the discount; a specific set of recipients of the discount, and any combination of these limitations.

19. An article of manufacture comprising a computer usable medium having computer readable program code means embodied therein for causing facilitation of distribution of coupons, the computer readable program code means in said article of manufacture comprising computer readable program code means for causing a computer to effect the steps of claim 1.

20. A program storage device readable by machine, tangibly embodying a program of instructions executable by the machine to perform method steps for facilitating distribution of coupons, said method steps comprising the steps of claim 1.

21. A computer program product comprising a computer usable medium having computer readable program code means embodied therein for causing provision of coupon business to at least one stores, the computer readable program code means in said computer program product comprising computer readable program code means for causing a computer to effect the functions of claim 16.

22. An apparatus for facilitating distribution of coupons for use at at least one store, comprising:
a coupon service bureau receiver to receive a request from a first user to obtain a targeted coupon for a targeted advantage; and
a coupon service bureau transmitter to forward said targeted coupon to said first user.

23. A computer program product comprising a computer usable medium having computer readable program code means embodied therein for causing facilitation distribution of coupons, the computer readable program code means in said computer program product comprising computer readable program code means for causing a computer to effect the functions of claim 22.

24. An apparatus comprising:
a portable coupon device used by a coupon user to provide user information;
an information processor for using said user information in providing a coupon advantage to said coupon user; and
a coupon downloader for downloading a coupon to said device.

25. An apparatus as recited in claim 24, further comprising an information transmitter to provide feedback to at least one coupon associate.

26. An apparatus as recited in claim 24, having a limitation taken from a group of limitations consisting of:
wherein said downloading is done from a provider taken from a group of providers consisting of: an Internet provider, a web site, a kiosk in a store, and a kiosk in a mall;
wherein said feedback includes data taken from groups of data consisting of: demographic information, buyer information, product information, time of day, service cost, product cost, and any combination of these data;
wherein said feedback to device users includes special information taken from a group of special information consisting of: product information, better offers at other stores, duration that coupon is good for, and any combination of these special information;
wherein said coupon service bureau is a third party that performs a task taken from a group of tasks consisting of: altering user of other similar coupons, alerting users as to location of products, and suggesting other coupon advantages;
wherein said coupon device permits said user to electronically trade and exchange coupons over a coupon exchange network maintained by the coupon service bureau;
wherein coupon exchange employs an exchange technique taken from a group of techniques consisting of: barter, sale, auction, and any combination of these techniques;
wherein the electronic exchange is restricted by a restriction taken from a group of restrictions consisting of: time limitations, location of a store limitations, location of exchangers of electronic coupons limitations, product limitations, and price limitations;
wherein the portable coupon device presents auxiliary information: taken from a group of auxiliary information consisting of: advertisements, product information, product manuals, consumer reports, and safety information;
wherein the user is a user taken from groups of users consisting of: individuals, companies, corporations, community groups, and governmental groups, and any combination of said groups;
wherein said user information is used to provide a set of coupons to said user;
wherein the user sends particular coupon information to the Coupon Service Bureau; and
wherein the coupon may only be used by a particular recipient; and any combination of these limitations.

27. A method as recited in claim 1, wherein the targeted advantage is an advantage taken from a group of advantages consisting of: a product discount, a service discount, a duration of discount, a rebate, a service feature, a service contract feature, a product feature, an ecological feature, a safety feature, a preferred instruction, and any combination of these advantages.

28. A computer program product comprising a computer usable medium having computer readable program code means embodied therein for causing facilitation distribution of coupons, the computer readable program code means in said computer program product comprising computer readable program code means for causing a computer to effect the functions of claim 24.
